(19) United States
(12) Patent Application Publication
(10) Pub. No.: US 2024/0054969 A1
(43) Pub. Date: Feb. 15, 2024

(54) METHOD FOR DRIVING A DISPLAY MODULE, DISPLAY MODULE AND DISPLAY DEVICE

(71) Applicant: Shanghai Tianma Micro-Electronics Co., Ltd., Shanghai (CN)

(72) Inventor: Hua CHEN, Shanghai (CN)

(73) Assignee: Shanghai Tianma Micro-Electronics Co., Ltd., Shanghai (CN)

(21) Appl. No.: 18/049,469

(22) Filed: Oct. 25, 2022

(30) Foreign Application Priority Data
Aug. 15, 2022 (CN) 202210973142.0

(51) Int. Cl. G09G 3/36; G09G 3/20

(52) U.S. Cl. CPC G09G 3/3614; G09G 3/2096; G09G 2310/06; G09G 2330/021; G09G 2320/0233

(57) ABSTRACT

A method for driving a display module, a display module and a display device are provided. The drive method includes: obtaining a common voltage value when the display module performs displaying in a current polarity inversion manner; and controlling the display module to perform displaying in a pre-stored polarity inversion manner when the common voltage value is out of a common voltage threshold range, the pre-stored polarity inversion manner being different from the current polarity inversion manner. In the drive method, the polarity inversion manner is adjusted such that an image is displayed in another polarity inversion manner.

### CROSS-REFERENCE TO RELATED APPLICATIONS

The present application claims priority to Chinese Patent Application No. 202210973142.0, filed on Aug. 15, 2022, the content of which is incorporated herein by reference in its entirety.

### TECHNICAL FIELD

The present disclosure relates to the technical field of display, and particularly to a method for driving a display module, a display module and a display device.

### BACKGROUND

For a liquid crystal display panel, the light transmittance of the liquid crystal is adjusted by applying voltages to a pixel electrode and a common electrode respectively to form an electric field that can control deflection of the liquid crystal molecules. In order to prevent degeneration of characteristics of the liquid crystal due to working under a constant voltage for a long time, the liquid crystal display panel is usually driven by an AC driving method in applications. Both a positive polarity and a negative polarity are required to drive the liquid crystal when displaying each frame. The existing driving methods include a dot inversion, a column inversion, a row inversion, and on the like. At present, the liquid crystal display panel has a problem of greenish failure, which affects the display effect.

### SUMMARY

In a first aspect, an embodiment of the present disclosure provides a method for driving a display module. The drive method includes steps of obtaining a common voltage value when the display module performs displaying in a current polarity inversion manner; and controlling the display module to perform displaying in a pre-stored polarity inversion manner when the common voltage value exceeds a common voltage threshold range, the pre-stored polarity inversion manner being different from the current polarity inversion manner.

In a second aspect, based on a same inventive concept, an embodiment of the present disclosure provides a display module, including a voltage detection module, a voltage comparison module and a polarity inversion control module. The voltage detection module is coupled to a common electrode in the display module and is configured to detect a common voltage value when the display module performs displaying in a current polarity inversion manner. The voltage comparison module is coupled to the voltage detection module, and the voltage comparison module is configured to compare the common voltage value with a common voltage threshold range, and when the common voltage value exceeds the common voltage threshold range, a comparison result is sent to the polarity inversion control module. The polarity inversion control module is coupled to the voltage comparison module, and the polarity inversion control module controls the display module to perform displaying in a pre-stored polarity inversion manner in response to the comparison result, the pre-stored polarity inversion manner being different from the current polarity inversion manner.

In a third aspect, based on a same inventive concept, an embodiment of the present disclosure provides a display device. The display device includes a display module, and the display module is driven by the drive method provided in any embodiment of the present disclosure.

### DESCRIPTION OF DRAWINGS

In order to better illustrate technical solutions in embodiments of the present disclosure or in the related art, the accompanying drawings used in the embodiments and in the related art are briefly introduced as follows. It should be noted that the drawings described as follows are merely part of the embodiments of the present disclosure, and other drawings can also be acquired by those skilled in the art without paying creative efforts.

FIG. 1 is a schematic diagram of a method for driving a display module in the related art;

FIG. 2 is a schematic diagram of a method for driving a display module in the related art;

FIG. 3 is a partial simplified schematic diagram of a display module according to an embodiment of the present disclosure;

FIG. 4 is a flowchart of a method for driving a display module according to an embodiment of the present disclosure;

FIG. 5 is a schematic diagram of displaying by using a drive method according to an embodiment of the present disclosure;

FIG. 6 is a flowchart of another method for driving a display module according to an embodiment of the present disclosure;

FIG. 7 is a schematic diagram of another method for driving a display module according to an embodiment of the present disclosure;

FIG. 8 is a schematic diagram of another method for driving a display module according to an embodiment of the present disclosure;

FIG. 9 is a schematic diagram of another method for driving a display module according to an embodiment of the present disclosure;

FIG. 10 is a schematic diagram of another method for driving a display module according to an embodiment of the present disclosure;

FIG. 11 is a schematic diagram of another method for driving a display module according to an embodiment of the present disclosure;

FIG. 12 is a schematic diagram of another method for driving a display module according to an embodiment of the present disclosure;

FIG. 13 is a schematic diagram of another method for driving a display module according to an embodiment of the present disclosure;

FIG. 14 is a schematic diagram of another method for driving a display module according to an embodiment of the present disclosure;

FIG. 15 is a schematic diagram of another method for driving a display module according to an embodiment of the present disclosure;

FIG. 16 is a modular schematic diagram of a display module according to an embodiment of the present disclosure;

FIG. 17 is a modular schematic diagram of another display module according to an embodiment of the present disclosure;

FIG. 18 is a schematic diagram of a display device according to an embodiment of the present disclosure; and

FIG. 19 is a flowchart of a method for driving a display module according to an embodiment of the present disclosure.

### DESCRIPTION OF EMBODIMENTS

In order to make the purpose, technical solutions, and advantages of the embodiments of the present disclosure be understandable, the technical solutions in the embodiments of the present disclosure are described in the following with reference to the accompanying drawings. It should be understood that the described embodiments are merely exemplary embodiments of the present disclosure, which shall not be interpreted as providing limitations to the present disclosure. All other embodiments obtained by those skilled in the art without creative efforts according to the embodiments of the present disclosure are within the scope of the present disclosure.

The terms used in the embodiments of the present disclosure are merely for the purpose of describing particular embodiments but not intended to limit the present disclosure. Unless otherwise noted in the context, the singular form expressions “a”, “an”, “the” and “said” used in the embodiments and appended claims of the present disclosure are also intended to represent plural form expressions thereof.

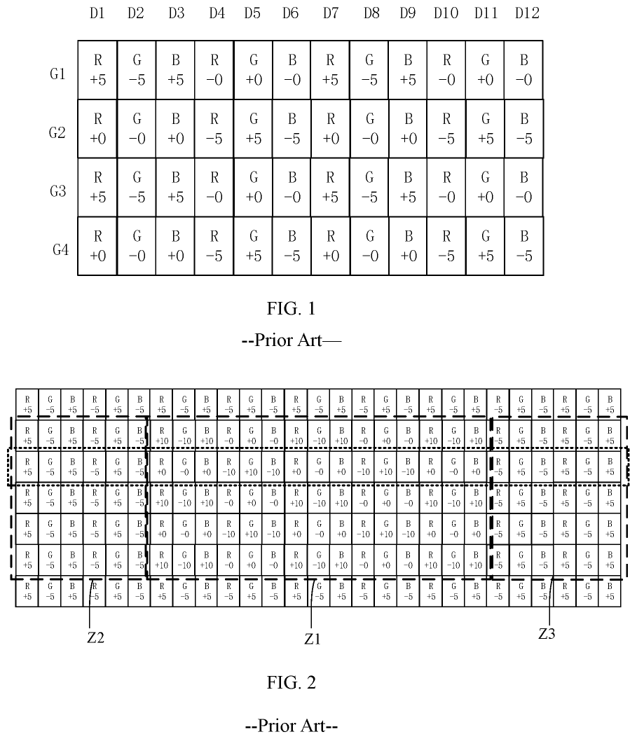

Conventionally, a display module has a fixed polarity inversion manner for displaying. FIG. 1 is a schematic diagram of a conventional method for driving a display module. As shown in FIG. 1, a white state voltage is +/−10V, and a black state voltage is +/−0V, and a common voltage is 0V FIG. 1 shows a column inversion driving mode, and +/−5V is used for displaying a grayscale of 128. FIG. 1 shows a part of a display area. Gate lines G1 to G4 each drive a respective one pixel row, and data lines D1 to D12 each drive a respective one pixel column. As shown in FIG. 1, R, G and B represent a red pixel, a green pixel, and a blue pixel, respectively. The following description is made with the displaying of a second pixel row driven by the gate line G2 in FIG. 1 as an example. When the second pixel row is driven for displaying a data voltage on the data line D1 jumps from a higher voltage to a lower voltage, and the voltage of the common electrode is pulled down by a coupling effect of the data line D1; a data voltage on the data line D2 jumps from a lower voltage to a higher voltage, and the voltage of the common electrode is pulled up by a coupling effect of the data line D2; a data voltage on the data line D3 jumps from a higher voltage to a lower voltage, and the voltage of the common electrode is pulled down by a coupling effect of the data line D3; and the voltage of the common electrode is pulled down by jumping of a data voltage of the data line D4. On the whole, the voltage on the common electrode may be pulled down by the coupling effect. When the gate electrode line G2 actives the second pixel row, the common voltage with a lower voltage value may be written into the second pixel row. Since the polarity of one G pixel in the second pixel row is positive when the second pixel row is activated, if the common voltage is a lower value, a voltage difference between a pixel electrode of the G pixel and the common electrode increases, thereby making the G pixel brighter. However, the polarity of the R pixel and the polarity of the B pixel are negative when the second pixel row is activated, and if the common voltage value has a lower value, a voltage difference between the pixel electrode of the R pixel (B pixel) and the common electrode decreases, thereby making both the R pixel and the B pixel darker. The human eye is more sensitive to green, as a result, an overall visual effect of the second pixel row is green. Based on the same reason, the displaying of the third pixel row and the fourth pixel row is also green, as a result, the overall displaying is green.

In FIG. 1, an image similar to a checkerboard is displayed for illustration, and the greenish phenomenon is illustrated. In practical applications, such as high-quality graphics or medical displays, some special images may be displayed. When displaying these special images, the greenish phenomenon is particularly serious, and affects the visual effect.

The inventor has found that when displaying some special images, there is a problem of display interference. FIG. 2 is a schematic diagram of another method for driving a display module in the related art. It is assumed that a white state voltage is +/−10V, a black state voltage is +/−0V, and a common voltage is 0V. In FIG. 2, an area Z1 marked with the dotted lines in the middle shows an image similar to a checkerboard, and a grayscale of 128 is displayed around it. The area around the area Z1 is divided into four areas, there are two display areas (an area Z2 and an area Z3) on the left and right sides of the area Z1, and another two display areas on the upper and lower sides of the area Z1. After testing, it has been found that the area Z2 and the area Z3 on two sides of the area Z1 have greater brightness. That is, the brightness on the left and right sides of the area Z1 is greater than the brightness on the upper and lower sides of the area Z1. This phenomenon is called display interference. Taking a pixel row marked in FIG. 2 as an example, when the pixels in the pixel row within the area Z1 perform displaying, the polarity of the data voltage on the data line jumps and pulls down the common voltage; and when the pixels in this pixel row and on the left and right sides of the area Z1 perform displaying, the pulling-up and pulling-down of the common voltage due to the jumping of the polarity of the data voltage on the data line in the area on the left side of the area Z1 and the area on the right side of the area Z1 counteract, so the common voltage is pulled down by coupling consequently. According to a relationship curve between the voltage across the liquid crystal and the transmittance, at the grayscale of 0 and the grayscale of 255, the voltage fluctuation has little effect on the liquid crystal transmittance, and thus the voltage fluctuation has little effect on the pixel brightness. As a result, when displaying the grayscale of 0 and the grayscale of 255 in the area Z1 shown in FIG. 2, there is no greenish problem, and the display can be normally performed. However, in the areas Z2 and Z3 on the left and right sides of the area Z1, the pixel display brightness increases due to the fluctuation of the common voltage, which makes the brightness on the left and right sides of the area Z1 different from the brightness on the upper and lower sides of the area Z1, resulting in display interference.

Conventionally, when displaying, the change of the voltage on the data line has a coupling effect on the common voltage, thereby causing the fluctuation of the common voltage, and the fluctuation of the common voltage may cause a poor display effect such as greenish display and display interference. In order to solve the above problem, an embodiment of the present disclosure provides a method for driving a display module, which changes a polarity inversion manner of the display module in response to detecting that a common voltage value on the common electrode exceeds a common voltage threshold range. That is, when it is determined that an image displayed in a current polarity inversion manner has a poor display effect, the polarity inversion manner is adjusted to display the image in another polarity inversion manner, thereby improving the display effect.

In an embodiment of the present disclosure, the display module is a liquid crystal display module, and the display module includes an array substrate, a color filter substrate, and a liquid crystal layer located between the array substrate and the color filter substrate. The array substrate includes a data line, a scan line, a transistor, a pixel electrode and a common electrode. The color filter substrate includes a black matrix and a color filter layer, and the color filter layer at least includes a red filter unit, a green filter unit and a blue filter unit. The black matrix has openings, in which the filter units are located.

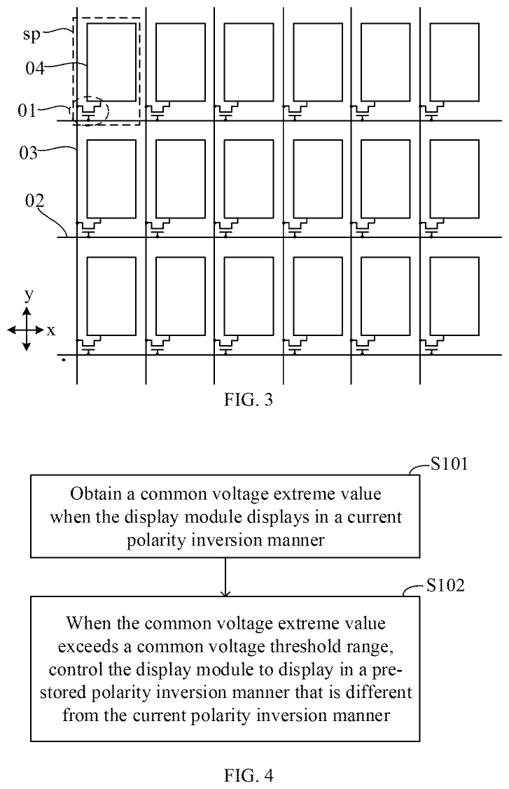

FIG. 3 is a partial simplified schematic diagram of a display module according to an embodiment of the present disclosure. A circuit structure is shown in FIG. 3. As shown in FIG. 3, the pixel sp includes a transistor 01 and a pixel electrode 04. The transistor 01 includes a gate electrode coupled to a gate line 02, a source electrode coupled to a data line 03, and a drain electrode coupled to the pixel electrode 04. The gate line 02 provides an enable signal to turn on the transistor 01, and a data voltage provided by the data line 03 is inputted into the pixel electrode 04. One gate electrode line 02 is coupled to the transistors 01 in multiple pixels in a row direction x, and one data line 03 is coupled to the transistors 01 in multiple pixels in a column direction y. In the display module, multiple pixels sp are arranged in the row direction x to form a pixel row, and multiple pixels sp are arranged in the column direction y to form a pixel column. The display module further includes a common electrode. When a common voltage is applied to the common electrode, a voltage difference between the common electrode and the pixel electrode 04 forms an electric field, and the liquid crystal molecules are deflected under control of the electric field. The degree of deflection of the liquid crystal affects the light transmittance of the liquid crystal, thereby affecting the brightness of the pixel.

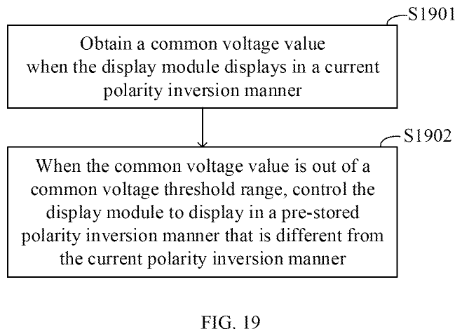

Various embodiments of the present disclosure provide a method for driving a display module. FIG. 19 is a flowchart of a method for driving a display module according to an embodiment of the present disclosure. As shown in FIG. 19, the drive method includes the following steps.

At step 1901, a common voltage value is obtained when the display module performs displaying in a current polarity inversion manner.

At step 1902, when the common voltage value is out of a common voltage threshold range, the display module performs displaying in a pre-stored polarity inversion manner that is different from the current polarity inversion manner.

For liquid crystal display panels, an electric field is formed between a common electrode and a pixel electrode. Deflection of liquid crystal molecule is controlled by this electric field. This electric field is formed by the voltage difference between the pixel electrode and the common electrode. Typically, a constant voltage is applied to the common electrode, a grayscale voltage (also referred to as data voltage) is applied to the pixel electrode. Data line for transmitting the grayscale voltage overlaps the common electrode, so the common voltage on the common electrode may be affected by changing of the grayscale voltage due to coupling effect and may not be the desired constant value. When it is detected that the common voltage value on the common electrode is out of the common voltage threshold range, it indicates that the common voltage has a great fluctuation, the image displayed in the current polarity inversion manner may have a poor display effect. Then, the display module is controlled to perform displaying in a pre-stored polarity inversion manner different from the current polarity inversion manner. By changing the polarity inversion manner, the common voltage may be in the common voltage threshold range.

In some embodiments, the common voltage threshold range has a maximum value and a minimum value, and at step 1902, it is determined that the common voltage value is out of the common voltage threshold range when the common voltage value is greater than the maximum value of the common voltage threshold range or when the common voltage value is smaller than the minimum value of the common voltage threshold range.

In some embodiments, whether the common voltage value is out of the common voltage threshold range is determined according to a common voltage extreme value. It is determined that the common voltage value is out of the common voltage threshold range when the common voltage extreme value exceeds a common voltage threshold range. FIG. 4 is a flowchart of a method for driving a display module according to an embodiment of the present disclosure. As shown in FIG. 4, the driving method includes the following steps.

At step S101, a common voltage extreme value when the display module performs displaying in a current polarity inversion manner is obtained. For example, a voltage detection module is provided in the display module, the voltage detection module is coupled to the common electrode, and a common voltage value on the common electrode is detected by the voltage detection module during displaying, so as to obtain the common voltage extreme value.

At step S102, when the common voltage extreme value exceeds a common voltage threshold range, the display module is controlled to perform displaying in a pre-stored polarity inversion manner, which is different from the current polarity inversion manner. That is, in the embodiments of the present disclosure, the common voltage threshold range is preset, and the obtained common voltage extreme value is compared with the common voltage threshold range, and when the common voltage extreme value exceeds the common voltage threshold range, the display module is controlled to change the polarity inversion manner.

In order to better illustrate the driving method provided by the embodiments of the present disclosure, several terms are explained in the following. Herein, a current polarity inversion manner is the polarity inversion manner adopted by the display module for displaying at the moment when the common voltage value on the common electrode of the display module is detected; a pre-stored polarity inversion manner is a polarity inversion manner that is per-stored and configured to alleviate a problem of a poor display effect. When the current polarity inversion manner leads to a poor display effect, the polarity inversion manner may be adjusted and changed to be a pre-stored polarity inversion manner. One, two or more than two pre-stored polarity inversion manners may be provided for the display module. The pre-stored polarity inversion manner may be a conventional polarity inversion manner, or a polarity inversion manner that is specifically defined. The display module has an initial polarity inversion manner, which is a default polarity inversion manner that is preset. When the display module displays a normal image or is in an initial state after the display module is turned on, the display module performs displaying in the initial polarity inversion manner.

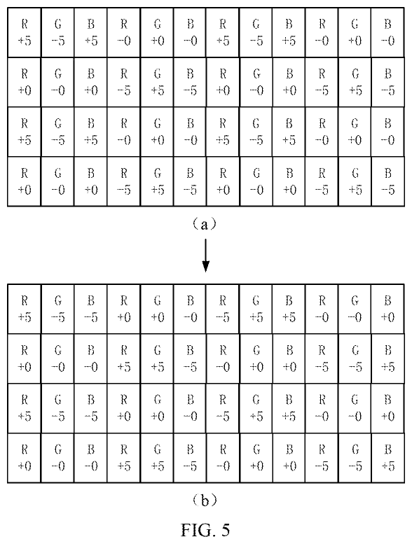

The drive method provided by the embodiments of the present disclosure can be described in the following by using a specific image display manner, in which the display of an image similar to a checkerboard is taken as an example. FIG. 5 is a schematic diagram of displaying by using the drive method provided by an embodiment of the present disclosure. As shown in FIG. 5, the drive method in figure (a) and the drive method in the figure (b) are used for displaying a same image. In figure (a), the displaying is performed in a current polarity inversion manner, and in figure (b), the displaying is performed in a pre-stored polarity inversion manner after adjustment. It is assumed that the white state voltage is +/−10V, the black state voltage is +/−0V, the common voltage is 0V, and +/−5V means that a grayscale of 128 is displayed. The current polarity inversion manner in the drive method shown in figure (a) is a column inversion manner. As stated in the above description, it is known that when the column inversion manner is adopted to display an image similar to a checkerboard, there will be a greenish problem. The figure (b) indicates that the display module performs displaying in a pre-stored polarity inversion manner, which can be understood as a horizontal 1+2 inversion manner, in which the polarity is inverted every two columns with the polarity of the first column being positive. Taking the second pixel row in the figure (b) as an example, according to the above-described principle regarding how the jump of the voltage on the data line affects the common voltage by coupling, it is known that when the second pixel row is activated, the jump of voltages on six data lines pulls up the common voltage by coupling, and the jump of voltages on other six data lines pulls down the common voltage by coupling, then the pull-up and pull-down effects on the common voltage can counteract each other, thus the common voltage basically does not have a fluctuation. Therefore, each pixel in the second pixel row can display accurate brightness, and there is no greenish problem. After the current column inversion manner is adjusted to a horizontal 1+2 inversion manner, the problem of poor display can be alleviated.

An embodiment of the present disclosure provides a method for driving a display module. The common voltage threshold range is preset. When it is detected that the common voltage extreme value on the common electrode exceeds the common voltage threshold range, it indicates that the common voltage has a great fluctuation, the image displayed in the current polarity inversion manner may have a poor display effect. In this way, the poor display can be detected by detecting the common voltage extreme value, and when the poor display is detected, the display module is controlled to perform displaying in a pre-stored polarity inversion manner. Herein, the pre-stored polarity inversion manner is different from the current polarity inversion manner, and the fluctuation of the common voltage is different when displaying a same image in different polarity inversion manners, then different polarity inversion manners have different display performances when displaying a same image. The pre-stored polarity inversion manner is beneficial to alleviating the problem of a poor display effect. In the embodiments of the present disclosure, when it is detected that the image displayed in the current polarity inversion manner has a poor display effect, another polarity inversion manner is adopted to display the image, thereby alleviating the problem of a poor display effect and improving the display effect.

It can be understood that when the display module displays an image, the jump of the voltage on the data line has a coupling effect on the common electrode, causing the fluctuation of the common voltage on the common electrode. However, when the fluctuation of the common voltage is small, the fluctuation of the common voltage has little influence on the brightness of the pixel, and the human eye may not recognize the brightness change. When the fluctuation of the common voltage is great, the brightness of the pixel can be greatly affected, resulting in poor display that is easily recognized by the human eye. In the embodiments of the present disclosure, a common voltage threshold range can be reasonably preset according to specific display requirements. When the common voltage extreme value exceeds the common voltage threshold range, the polarity inversion manner can be adjusted; and when the common voltage extreme value is within the common voltage threshold range, the current polarity inversion manner is still used for displaying.

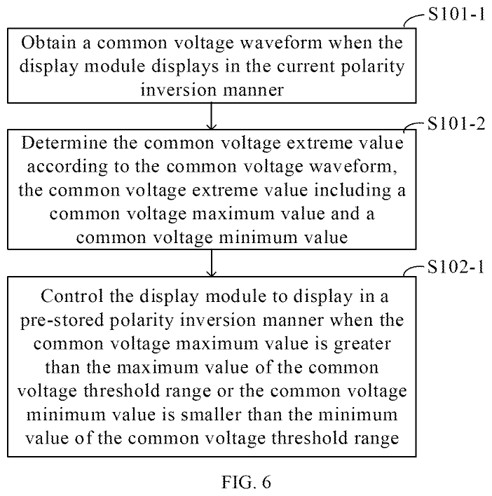

FIG. 6 is a flowchart of another method for driving a display module according to an embodiment of the present disclosure. In some embodiments of the present disclosure, as shown in FIG. 6, the drive method includes the following steps.

At step S101-1, a common voltage waveform when the display module performs displaying in the current polarity inversion manner is obtained. In an example, the voltage detection module is configured to detect the common voltage, and the common voltage waveform can be obtained by continuously sensing the common voltage within a period of time. In some embodiments of the present disclosure, an oscilloscope may be adopted to obtain the common voltage waveform.

At step S101-2, the common voltage extreme value is determined according to the common voltage waveform, and the common voltage extreme value includes a common voltage maximum value and a common voltage minimum value. By comparing the common voltage maximum value and the common voltage minimum value with the common voltage threshold range, the fluctuation of the common voltage can be characterized, thereby determining whether the common voltage has a great fluctuation.

At step S102-1, when the common voltage maximum value is greater than the maximum value of the common voltage threshold range or smaller than the minimum value of the common voltage threshold range, the display module is controlled to perform displaying in a pre-stored polarity inversion manner.

The maximum value of the common voltage and the minimum value of the common voltage are compared with the common voltage threshold range. When the maximum value of the common voltage and the minimum value of the common voltage are within the common voltage threshold range, it means that the common voltage has a small fluctuation, and the fluctuation of the common voltage has a small influence on the brightness of the pixel. In this case, the display module performs displaying in the current polarity inversion manner. When the maximum value of the common voltage or the minimum value of the common voltage exceeds the common voltage threshold range, it means that the common voltage has a great fluctuation, and the fluctuation of the common voltage has a great influence on the pixel brightness. In this case, the display module is controlled to change the polarity inversion manner, so that the display module is controlled to perform displaying in a pre-stored polarity inversion manner.

For the display module provided by the embodiments of the present disclosure, the common voltage extreme value is obtained by collecting the common voltage waveform. That is, the change of the common voltage value within a period of time is collected to represent the fluctuation of the common voltage, then the fluctuation of the common voltage can be analyzed more accurately. Moreover, the two cases (i.e., a case that the common voltage maximum value is greater than the maximum value of the common voltage threshold range, and another case that the common voltage minimum value is smaller than the minimum value of the common voltage threshold range) are both considered as the common voltage extreme value exceeding the common voltage threshold range, so as to ensure that both the positive fluctuation of the common voltage (i.e., the fluctuation of the common voltage that is pulled up by coupling) and the negative fluctuation of the common voltage (i.e., the fluctuation of the common voltage that is pulled down by coupling) can be accurately detected.

In some embodiments of the present disclosure, the step S1011 of obtaining the common voltage waveform when the display module performs displaying in the current polarity inversion manner includes obtaining the common voltage waveform by acquiring common voltage values when the display module continuously displays N pixel rows, where N is a positive integer and N is not greater than a total number of pixel rows in the display module. It can be understood that when all pixel rows in the display module are refreshed once, one frame of image is displayed. In some embodiments of the present disclosure, the cycle of sampling the common voltage waveform is equal to the period of displaying a complete frame of image by the display module, that is, the common voltage values are acquired during a period when the display module displays a complete frame of image. In other embodiments of the present disclosure, the cycle of sampling the common voltage waveform is shorter than the period of displaying a complete frame of image by the display module, that is, the common voltage values are sampled only during a period when part of the pixel rows is displayed. In the embodiments of the present disclosure, the common voltage waveform is obtained by using the common voltage values acquired in a continuous period of time, and the fluctuation of the common voltage can be more accurately characterized. In this case, when the common voltage has a great fluctuation, the polarity inversion manner can be changed, so that the problem of a poor display effect can be alleviated by adjusting the polarity inversion manner.

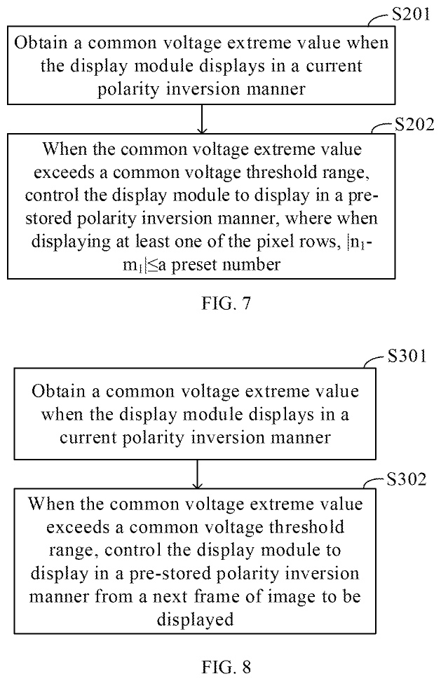

FIG. 7 is a schematic diagram of another method for driving a display module according to an embodiment of the present disclosure. In some embodiments of the present disclosure, as shown in FIG. 7, the drive method includes the following steps.

At step S201, a common voltage extreme value when the display module performs displaying in a current polarity inversion manner is obtained.

At step S202, when the common voltage extreme value exceeds a common voltage threshold range, the display module is controlled to perform displaying in a pre-stored polarity inversion manner, and when controlling to display at least part of the pixel rows, |n₁−m₁|≤a preset number, where n1 denotes a number of data lines on which the data voltage jumps from a lower level to a higher level when displaying in the pre-stored polarity inversion manner, and m₁ denotes a number of data lines on which the data voltage jumps from a higher level to a lower level when displaying in the pre-stored polarity inversion manner, and both n1 and m₁ are positive integers.

When displaying, the jump of the data voltage on the data line has a coupling effect on the common voltage on the common electrode. A low-to-high jump of the data voltage may pull up the common voltage by coupling, and a high-to-low jump of the data voltage may pull down the common voltage by coupling. When displaying a pixel row, if there is a large difference between the pull-up of the common voltage and the pull-down of the common voltage, the common voltage has a fluctuation and deviates from a preset value. When the common voltage that deviates from the preset value is inputted into the pixel row, abnormal light-emitting brightness of the pixel can be caused, thereby resulting in a poor display effect. In the embodiments of the present disclosure, displaying is controlled to be performed in a pre-stored polarity inversion manner, and when at least part of the pixel rows are displayed, |n₁−m₁|≤a preset number. The preset number can be determined by referring to a total number of data lines in the display module, a type of a specific image that is displayed, an initial polarity inversion manner that is preset in the display module, and other factors. Herein, |n₁−m₁|≤a preset number, so that a degree of pulling up the common voltage due to the jump of the voltage on the data line by coupling is slightly different from a degree of pulling down the common voltage due to the jump of the voltage on the data line by coupling when displaying at least part of the pixel rows, thereby reducing the fluctuation of the common voltage. Thus, a poor display effect, such a greenish display phenomenon or display interference caused by the fluctuation of the common voltage, can be alleviated. The smaller the preset number is, the smaller the fluctuation of the voltage is when a preset polarity inversion manner is adopted for displaying.

In some embodiments of the present disclosure, at step S202, when the common voltage extreme value exceeds the common voltage threshold range, the display module is controlled to perform displaying in a pre-stored polarity inversion manner, and n₁=m₁ when at least part of the pixel rows is controlled to be displayed. That is, when displaying at least part of the pixel rows in a pre-stored polarity inversion manner, the number of data lines on each of which the data voltage jumps from a lower level to a higher level is equal to the number of data lines on each of which the data voltage jumps from a higher level to a lower level. Then, the pull-up of the common voltage due to the jump of the voltages on the data lines and the pull-down of the common voltage due to the jump of the voltages on the data lines can counteract each other, and thus the common voltage basically does not have a fluctuation when displaying at least part of the pixels rows in pre-stored polarity inversion manner. Therefore, each pixel in at least part of pixel rows can display accurate with brightness, without a problem of a poor display effect such as greenish display and display interference

In some other embodiments of the present disclosure, the step of controlling the display module to perform displaying in a pre-stored polarity inversion manner includes: when controlling the display module to display a p-th pixel row, |n₁−m₁|<Δp, where p is a positive integer. Herein, Δp=|n₀−m₀|, where n₀ denotes a number of data lines on each of which the data voltage jumps from a lower level to a higher level when the p-th pixel row is displayed in the current polarity inversion manner, and m₀ denotes a number of data lines on each of which the data voltage jumps from a higher level to a lower level when the p-th pixel row is displayed in the current polarity inversion manner.

When detecting the fluctuation of the common voltage on the display module, the display module performs displaying in the current polarity inversion manner. It can be understood that the current polarity inversion manner is a polarity inversion manner adopted for displaying when detecting the common voltage extreme value, not a specific polarity inversion manner. Herein, Δp represents a difference between the number of data lines which pull down the common voltage by coupling and the number of data lines which pull up the common voltage by coupling when the p-th pixel row is displayed in the current polarity inversion manner, and the value of Δp can reflect the fluctuation of the common voltage when the p-th pixel row are displayed in the current polarity inversion manner. In the embodiments of the present disclosure, when the p-th pixel row is displayed in the pre-stored polarity inversion manner, |n₁−m₁|<Δp, so that the fluctuation of the common voltage caused by jump of the data voltage when the p-th pixel row is displayed in the pre-stored polarity inversion manner is smaller than the fluctuation of the common voltage when the p-th pixel row is displayed in the current polarity inversion manner. Then, when the p-th pixel row is displayed in a pre-stored polarity inversion manner, each pixel can display more accurate brightness, and the problem of a poor display effect can be alleviated.

In other embodiments of the present disclosure, the step of S202 of controlling the display module to perform displaying in a pre-stored polarity inversion manner includes: |n₁−m₁|≤a preset number when controlling at least M pixel rows in the display module, where M denotes half of a total number of pixel rows in the display module. Such a configuration can lead to a small fluctuation of the common voltage when half or more than half of the pixel rows in the display module are displayed in a pre-stored inversion manner, thereby alleviating a problem of a poor display effect of most pixel rows, and thus improving an overall display effect.

FIG. 8 is a schematic diagram of another method for driving a display module according to an embodiment of the present disclosure. In some embodiments of the present disclosure, as shown in FIG. 8, the drive method includes the following steps.

At step S301, a common voltage extreme value when the display module performs displaying in a current polarity inversion manner is obtained.

At step S302, when the common voltage extreme value exceeds a common voltage threshold range, the display module is controlled to perform displaying in a pre-stored polarity inversion manner from a next frame of image to be displayed.

This embodiment determines the timing of adjusting and changing the polarity inversion manner after it is detected that the common voltage has a great fluctuation. Displaying is performed in a pre-stored polarity inversion manner from a next frame of image to be displayed, then a poor display effect such as greenish display or display interference can be alleviated from the next frame of the image to be displayed.

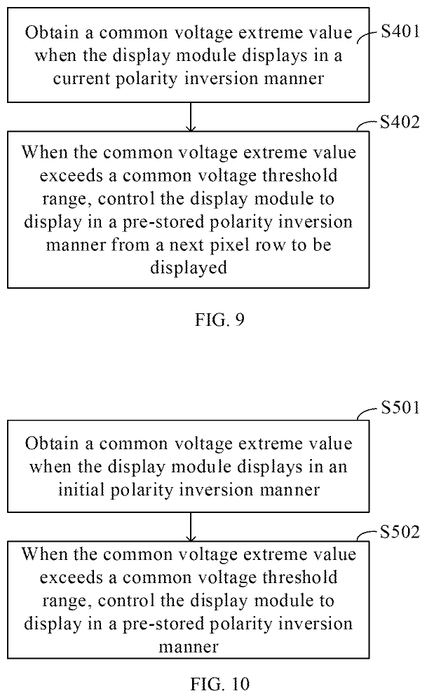

FIG. 9 is a schematic diagram of another method for driving a display module according to an embodiment of the present disclosure. In some embodiments of the present disclosure, as shown in FIG. 9, the drive method includes the following steps.

At step S401, a common voltage extreme value when the display module performs displaying in a current polarity inversion manner is obtained.

At step S402, when the common voltage extreme value exceeds a common voltage threshold range, the display module is controlled to display in a pre-stored polarity inversion manner from a next pixel row to be displayed.

This embodiment determines the time of adjusting and changing the polarity inversion manner after it is detected that the common voltage has a great fluctuation. The polarity inversion manner is changed within a current displaying frame, then a poor display effect such as greenish display or display interference can be alleviated from a next pixel row to be displayed.

In some embodiments of the present disclosure, an initial polarity inversion manner is preset in the display module, and the initial polarity inversion manner is different from the pre-stored polarity inversion manner. The initial polarity inversion manner is a default polarity inversion manner that is preset. When the display module displays a normal image or is in an initial state after the display module is turned on, the display module performs displaying in the initial polarity inversion manner. FIG. 10 is a schematic diagram of another method for driving a display module according to an embodiment of the present disclosure. As shown in FIG. 10, the driving method includes the following steps.

At step S501, a common voltage extreme value when the display module performs displaying in an initial polarity inversion manner is obtained. At Step S502, when the common voltage extreme value exceeds a common voltage threshold range, the display module is controlled to perform displaying in a pre-stored polarity inversion manner.

With the drive method provided by the embodiments of the present disclosure, when it is detected that the common voltage extreme value exceeds the common voltage threshold range when displaying in the initial polarity inversion manner, it indicates that the common voltage has a great fluctuation, and an image displayed in an initial polarity inversion manner will have a poor display defect. At this time, the image is displayed in a pre-stored polarity inversion manner by adjusting the polarity inversion manner, thereby alleviating poor display and improving the display effect.

In some embodiments of the present disclosure, only one pre-stored polarity inversion manner is pre-stored in the display module. When it is detected that the common voltage has a great fluctuation when displaying in the initial polarity inversion manner, the inversion manner is changed, so that the display module is controlled to perform displaying in a pre-stored polarity inversion manner.

In an embodiment of the present disclosure, the initial polarity inversion manner is a column inversion manner, and the pre-stored polarity inversion manner is a dot inversion manner.

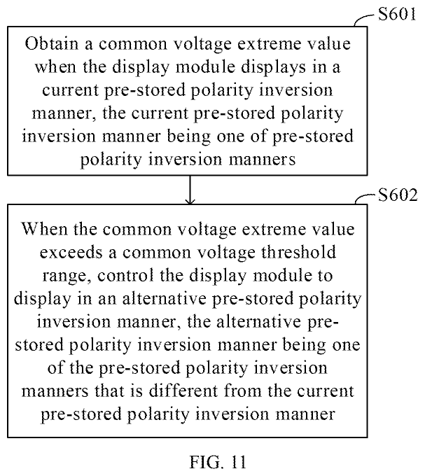

In some embodiments of the present disclosure, the pre-stored polarity inversion manner includes at least two different polarity inversion manners, that is, two or more pre-stored polarity inversion manners are pre-stored in the display module. FIG. 11 is a schematic diagram of another method for driving a display module according to an embodiment of the present disclosure. As shown in FIG. 11, the driving method includes the following steps.

At step S601, a common voltage extreme value when the display module performs displaying in a current pre-stored polarity inversion manner is obtained, and the current pre-stored polarity inversion manner is one of pre-stored polarity inversion manners.

At step S602, when the common voltage extreme value exceeds a common voltage threshold range, the display module is controlled to perform displaying in an alternative pre-stored polarity inversion manner, and the alternative pre-stored polarity inversion manner is one of the pre-stored polarity inversion manners that is different from the current pre-stored polarity inversion manner.

In applications, the display module first displays in an initial polarity inversion manner. When it is detected that the common voltage has a great fluctuation when displaying in the initial polarity inversion manner, the display module is controlled to perform displaying in a pre-stored polarity inversion manner. The display module performs displaying in the pre-stored polarity inversion manner and continues detecting the common voltage, and when it is detected that the common voltage has a great fluctuation when displaying in the current pre-stored polarity inversion manner, the display module is controlled to perform displaying in another pre-stored polarity inversion manner. That is, at this time, the problem of a poor display effect can be further alleviated by changing the polarity inversion manner. In the embodiments of the present disclosure, at least two different polarity inversion manners are pre-store in the display module, the display module can have wider applicability, and a problem of a poor display effect of some unknown special images can be alleviated.

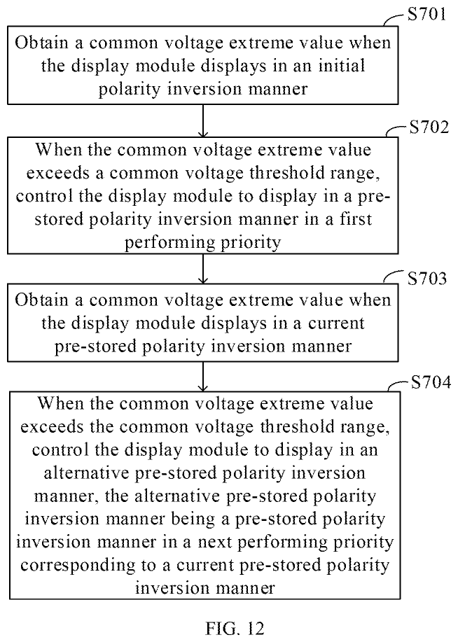

In some other embodiments of the present disclosure, a performing order of the pre-stored polarity inversion manners is described when the pre-stored polarity inversion manners include at least two different polarity inversion manners. FIG. 12 is a schematic diagram of another method for driving a display module according to an embodiment of the present disclosure. As shown in FIG. 12, the performing order of the at least two different polarity inversion manners in the pre-stored polarity inversion manners is determined. The drive method includes the following steps.

At step S701, a common voltage extreme value when the display module performs displaying in an initial polarity inversion manner is obtained, and the initial polarity inversion manner is a current polarity inversion manner.

At step S702, when the common voltage extreme value exceeds a common voltage threshold range, the display module is controlled to perform displaying in a pre-stored polarity inversion manner with a first performing priority.

At step S703, the common voltage extreme value when the display module performs displaying in the current pre-stored polarity inversion manner is obtained, where the current polarity inversion manner is a pre-stored polarity inversion manner.

At step S704, when the common voltage extreme value exceeds the common voltage threshold range, the display module is controlled to perform displaying in an alternative pre-stored polarity inversion manner, and the alternative pre-stored polarity inversion manner is a pre-stored polarity inversion manner with a next performing priority corresponding to the current pre-stored polarity inversion manner.

In this embodiment, the performing order of two or more pre-stored polarity inversion manners pre-stored in the display module is described, that is, priority levels are set for the pre-stored polarity inversion manners. When it is detected that the common voltage has a great fluctuation when displaying in an initial polarity inversion manner, the display module is controlled to perform displaying in a pre-stored polarity inversion manner with a first performing priority. The display module performs displaying in the current pre-stored polarity inversion manner and continues detecting the common voltage. When it is detected that the common voltage still has a great fluctuation when displaying in the current pre-stored polarity inversion manner, the display module is controlled to perform displaying in a pre-stored polarity inversion manner with a next performing priority corresponding to the current pre-stored polarity inversion manner. When displaying some special images, if it is detected that the common voltage extreme value still exceeds the common voltage threshold range after changing the polarity inversion manner, the polarity manner can be changed again. The preset pre-stored polarity inversion manners may be adopted one by one to alleviate the problem of a poor display effect. At least two different polarity inversion manners are pre-stored in the display module, so that the display module has wider applicability, and a problem of a poor display effect of some unknown special images can also be alleviated.

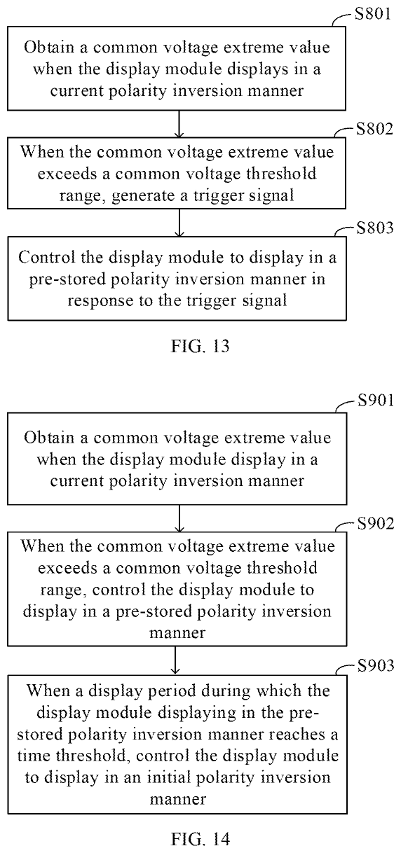

FIG. 13 is a schematic diagram of another method for driving a display module according to an embodiment of the present disclosure. In some embodiments of the present disclosure, as shown in FIG. 13, the drive method includes the following steps.

At step S801, a common voltage extreme value when the display module performs displaying in a current polarity inversion manner is obtained.

At step S802, when the common voltage extreme value exceeds a common voltage threshold range, a trigger signal is generated.

At step S803, the display module is controlled to perform displaying in a pre-stored polarity inversion manner in response to the trigger signal.

A timing controller is provided in the display module. The timing controller is controlled by the trigger signal. The timing controller is configured to adjust the polarity of the data voltage applied to the data line. Under control of the timing controller, the polarity inversion manner adopted by the display module is controlled.

In some embodiments of the present disclosure, a polarity inversion signal is preset in the display module, and the polarity inversion signal is configured to control the polarity of the data voltage. One, two, or more than two polarity inversion signals may be set in the display module. The Step S803 of controlling the display module to perform displaying in a pre-stored polarity inversion manner in response to the trigger signal includes changing at least one polarity inversion signal in response to the trigger signal, so as to control the display module to perform displaying in a pre-stored polarity inversion manner. The polarity of the data voltage applied to the data line can be controlled by adjusting the polarity inversion signal, and the coordination of different polarity inversion signals can realize different polarity inversion manners such as column inversion display manner and a dot inversion display manner of the display module. In the drive method provided by the embodiments of the present disclosure, when it is detected that the common voltage extreme value exceeds a common voltage threshold range, a trigger signal is generated, and at least one polarity inversion signal is changed by triggering of the trigger signal. In this way, the polarity inversion manner used in displaying can be changed. Therefore, displaying can be performed in another polarity inversion manner by adjusting the polarity inversion manner, thereby alleviating the poor display and improving the display effect.

FIG. 14 is a schematic diagram of another method for driving a display module according to an embodiment of the present disclosure. In some embodiments of the present disclosure, as shown in FIG. 14, the drive method includes the following steps.

At step S901, a common voltage extreme value when the display module performs displaying in a current polarity inversion manner is obtained.

At step S902, when the common voltage extreme value exceeds a common voltage threshold range, the display module is controlled to perform displaying in a pre-stored polarity inversion manner.

At step S903, when a display period during which the display module performs displaying in the pre-stored polarity inversion manner reaches a time threshold, the display module is controlled to perform displaying in an initial polarity inversion manner.

The drive method provided by this embodiment has a time threshold. After displaying in the pre-stored polarity inversion manner for a certain period of time, the display module is controlled to perform displaying in the initial polarity inversion manner. The initial polarity inversion manner is generally set in consideration of factors such as display power consumption. When the display module adopts the initial polarity inversion manner to display conventional images, the problem of a poor display effect usually does not exist. However, when some special images are displayed in the initial polarity inversion manner, there may be display problems such as greenish display or interference. With the drive method provided by the embodiments of the present disclosure, the timing of adjusting back to the initial polarity inversion manner is set, so that the display problem such as greenish display or interference can be alleviated when displaying some special images in the pre-stored polarity inversion manner. When displaying normal images, displaying is performed in the initial polarity inversion manner. In this way, power consumption and display effects can be balanced to meet display requirements for different images.

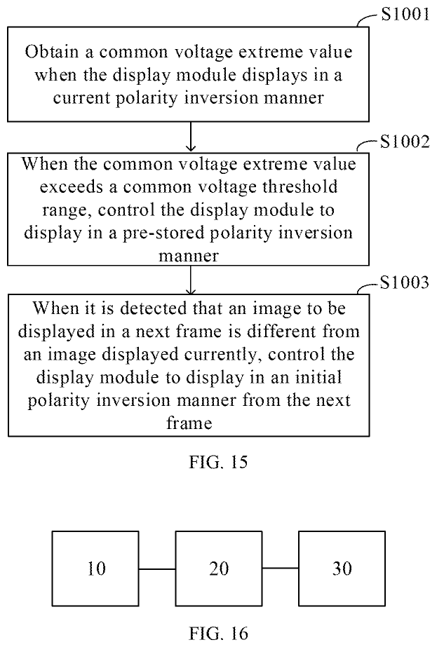

FIG. 15 is a schematic diagram of another method for driving a display module according to an embodiment of the present disclosure. In some embodiments of the present disclosure, as shown in FIG. 15, the drive method includes the following steps.

At step S1001, a common voltage extreme value when the display module performs displaying in a current polarity inversion manner is obtained.

At step S1002, when the common voltage extreme value exceeds a common voltage threshold range, the display module is controlled to perform displaying in a pre-stored polarity inversion manner.

At step S1003, when it is detected that an image to be displayed in a next frame is different from an image displayed currently, the display module is controlled to perform displaying in an initial polarity inversion manner from the next frame.

In the drive method provided by this embodiment, displaying is performed in a pre-stored polarity inversion manner with detecting an image to be displayed, and when the image to be displayed in a next frame is different from an image displayed currently, the display module is controlled to perform displaying in an initial polarity inversion manner. The timing of adjusting back to the initial polarity inversion manner is set by detecting the image to be displayed, so that the display problem such as greenish display or interference can be alleviated when displaying some special images in the pre-stored polarity inversion manner; and when displaying normal images, displaying is performed in the initial polarity inversion manner. In this way, power consumption and display effects can be balanced to meet display requirements for different images.

In addition, it should be noted that the steps in the driving method provided by the embodiments of the present disclosure may be combined when there is no conflict.

Based on a same inventive concept, an embodiment of the present disclosure further provides a display module, and the display module can be driven by the drive method provided in any embodiment of the present disclosure. FIG. 16 is a block schematic diagram of a display module according to an embodiment of the present disclosure. As shown in FIG. 16, the display module includes a voltage detection module 10, a voltage comparison module 20, and a polarity inversion control module 30.

The voltage detection module 10 is coupled to a common electrode in the display module, and the voltage detection module 10 is configured to detect a common voltage extreme value when the display module performs displaying in a current polarity inversion manner.

The voltage comparison module 20 is coupled to the voltage detection module 10. The voltage comparison module 20 is configured to compare the common voltage extreme value with a common voltage threshold range. When the common voltage extreme value exceeds the common voltage threshold range, a comparison result is sent to the polarity inversion control module 30.

The polarity inversion control module 30 is coupled to the voltage comparison module 20, and controls the display module to perform displaying in a pre-stored polarity inversion manner in response to the comparison result. The pre-stored polarity inversion manner is different from the current polarity inversion manner.

With the drive module provided by the embodiments of the present disclosure, a common voltage extreme value is obtained by detection, and then the common voltage extreme value is compared with a common voltage threshold range. When the common voltage extreme value exceeds the common voltage threshold range, the polarity inversion manner is changed. Therefore, in the embodiments of the present disclosure, when it is determined that an image displayed in a current polarity inversion manner has a poor display effect, the polarity inversion manner is adjusted to display the image in another polarity inversion manner, thereby alleviating poor display and improving the display effect.

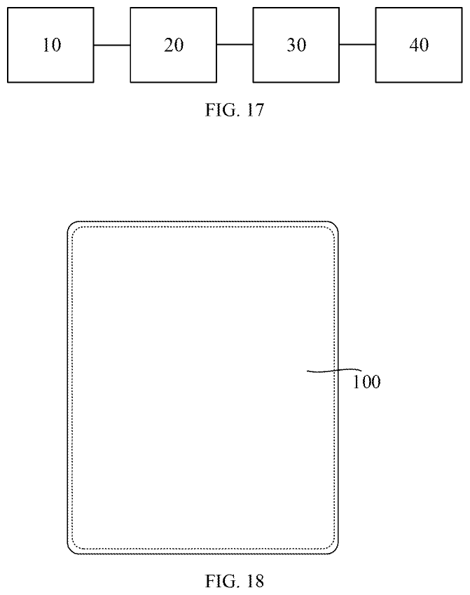

FIG. 17 is a modular schematic diagram of another display module according to an embodiment of the present disclosure. In an embodiment of the present disclosure, as shown in FIG. 17, the display module further includes a timing controller 40, and the timing controller 40 is coupled to the polarity inversion control module 30. The polarity inversion control module 30 generates a touch signal in response to the comparison result and sends the trigger signal to the timing controller 40. The timing controller 40 changes at least one polarity inversion signal in response to the trigger signal, so as to control the display module to perform displaying in a pre-stored polarity inversion manner.

The timing controller 40 is configured to adjust the polarity of the data voltage applied to the data line. The timing controller 40 can control the polarity inversion signal, so as to control the polarity of the data voltage applied to the data line, and the cooperation of different polarity inversion signals can realize different polarity inversion manners of the display module, such as a column inversion display manner, a dot inversion display manner, and the like. For the display module provided by the embodiments of the present disclosure, when it is detected that the common voltage extreme value exceeds the common voltage threshold range, a trigger signal is generated, and at least one polarity inversion signal is controlled to be changed under triggering of the trigger signal, so as to change the polarity inversion manner for displaying. Therefore, an image can be displayed in another polarity inversion manner by adjusting the polarity inversion manner, thereby alleviating poor display and improving the display effect.

Based on the same inventive concept, an embodiment of the present disclosure further provides a display device. FIG. 18 is a schematic diagram of a display device according to an embodiment of the present disclosure. As shown in FIG. 18, the display device includes a display module 100, and the display module 100 can be driven by using the drive method provided by any embodiment of the present disclosure. The structure of the display module 100 and the drive method have been described in the foregoing embodiments and will not be repeated herein. The display device provided by the embodiments of the present disclosure may be any device having a display function, such as a mobile phone, a tablet computer, a notebook computer, and a television.

The above-described embodiments are merely preferred embodiments of the present disclosure and are not intended to limit the present disclosure. Any modifications, equivalent substitutions and improvements made within the principle of the present disclosure shall fall into the protection scope of the present disclosure.

Finally, it should be noted that the above-described embodiments are merely for illustrating the present disclosure but not intended to provide any limitation. Although the present disclosure has been described in detail with reference to the above-described embodiments, it should be understood by those skilled in the art that, it is still possible to modify the technical solutions described in the above embodiments or to equivalently replace some or all of the technical features therein, but these modifications or replacements do not cause the essence of corresponding technical solutions to depart from the scope of the present disclosure.

1. A method for driving a display module, comprising:
obtaining a common voltage waveform when the display module displays in a current polarity inversion manner;
obtaining a common voltage extreme value of the common voltage waveform, the common voltage extreme value comprising a common voltage maximum value and a common voltage minimum value; and
controlling the display module to display in a pre-stored polarity inversion manner when the common voltage maximum is greater than a maximum value of a common voltage threshold range or when the common voltage minimum value is smaller than a minimum value of the common voltage threshold range,
wherein controlling the display module to display in a pre-stored polarity inversion manner comprises:
when displaying a p-th pixel row in the display module, |n₁−m₁|<Δp, where n₁ denotes a number of data lines on each of which a data voltage jumps from a lower level to a higher level when displaying in the pre-stored polarity inversion manner, m₁ denotes a number of data lines on each of which a data voltage jumps from a higher level to a lower level when displaying in the pre-stored polarity inversion manner, and n₁, m₁ and p are positive integers, Δp=|n₀−m₀|, no denotes a number of data lines on each of which a data voltage jumps from a lower level to a higher level when the p-th pixel row is displayed in the current polarity inversion manner, and m₀ denotes a number of data lines on each of which a data voltage jumps from a higher level to a lower level when the p-th pixel row is displayed in the current polarity inversion manner.

2-3. (canceled)

4. The method according to claim 1, wherein obtaining a common voltage waveform when the display module displays in the current polarity inversion manner comprises:
obtaining the common voltage waveform by collecting common voltage values when the display module continuously displays N pixel rows, where N is a positive integer and N is not greater than a total number of pixel rows in the display module.

5-7. (canceled)

8. The method according to claim 1, wherein controlling the display module to display in a pre-stored polarity inversion manner comprises:
when displaying at least M pixel rows in the display module, |n₁−m₁|≤a preset number, where M is equal to half of a total number of pixel rows in the display module, n1 denotes a number of data lines on each of which a data voltage jumps from a lower level to a higher level when displaying in the pre-stored polarity inversion manner, m1 denotes a number of data lines on each of which a data voltage jumps from a higher level to a lower level when displaying in the pre-stored polarity inversion manner, and both n₁ and m₁ are positive integers.

9. The method according to claim 1, wherein controlling the display module to display in a pre-stored polarity inversion manner comprises:
controlling the display module to display in the pre-stored polarity inversion manner from a next frame of image to be displayed.

10. The method according to claim 1, wherein the controlling the display module to display in a pre-stored polarity inversion manner comprises:
controlling the display module to display in a pre-stored polarity inversion manner from a next pixel row to be displayed.

11. The method according to claim 1, wherein an initial polarity inversion manner is preset in the display module, and the initial polarity inversion manner is different from the pre-stored polarity inversion manner;
wherein obtaining a common voltage value when the display module displays in a current polarity inversion manner comprises obtaining the common voltage value when the display module displays in the initial polarity inversion manner.

12. The method according to claim 11, wherein the pre-stored polarity inversion manner comprises at least two different pre-stored polarity inversion manners;
wherein obtaining a common voltage value when the display module displays in a current polarity inversion manner further comprises:
obtaining the common voltage value when the display module displays in a current pre-stored polarity inversion manner, the current pre-stored polarity inversion manner being one of the at least two different pre-stored polarity inversion manners; and
wherein controlling the display module to display in a pre-stored polarity inversion manner comprises:
controlling the display module to display in an alternative pre-stored polarity inversion manner, the alternative pre-stored polarity inversion manner being another one of the at least two different pre-stored polarity inversion manners, which is different from the current pre-stored polarity inversion manner.

13. The method according to claim 12, further comprising determining a performing order of the at least two different pre-stored polarity inversion manners;
wherein controlling the display module to display in a pre-stored polarity inversion manner comprises:
controlling the display module to display in the pre-stored polarity inversion manner with a first performing priority when the current polarity inversion manner is the initial polarity inversion manner; and
controlling the display module to display in an alternative pre-stored polarity inversion manner when the current polarity inversion manner is the current pre-stored polarity inversion manner, the alternative pre-stored polarity inversion manner having a next performing priority corresponding to the current pre-stored polarity inversion manner.

14. The method according to claim 1, wherein controlling the display module to display in a pre-stored polarity inversion manner when the common voltage maximum value is greater than a maximum value of a common voltage threshold range or when the common voltage minimum value is smaller than a minimum value of the common voltage threshold range comprises:
generating a trigger signal when the common voltage value is out of the common voltage threshold range; and
controlling the display module to display in the pre-stored polarity inversion manner in response to the trigger signal.

15. The method according to claim 14, wherein a polarity inversion signal is preset in the display module, and the polarity inversion signal is configured to control a polarity of a data voltage;
wherein controlling the display module to display in the pre-stored polarity inversion manner in response to the trigger signal comprises changing at least one polarity inversion signal of the polarity inversion signal in response to the trigger signal, so as to control the display module to display in the pre-stored polarity inversion manner.

16. The method according to claim 1, wherein an initial polarity inversion manner is preset in the display module, and the initial polarity inversion manner is different from the pre-stored polarity inversion manner;
wherein the method further comprises:
controlling the display module to display in the initial polarity inversion manner when a display period during which the display module displays in the pre-stored polarity inversion manner reaches a time threshold.

17. The method according to claim 1, wherein an initial polarity inversion manner is preset in the display module, and the initial polarity inversion manner is different from the pre-stored polarity inversion manner;
wherein the method further comprises:
controlling the display module to display in the initial polarity inversion manner from a next frame when it is detected that an image to be displayed in the next frame is different from an image displayed currently.

18. A display module, comprising a voltage detection module, a voltage comparison module and a polarity inversion control module;
wherein the voltage detection module is coupled to a common electrode in the display module, and the voltage detection module is configured to detect a common voltage extreme value from a common voltage waveform when the display module displays in a current polarity inversion manner;
wherein the voltage comparison module is coupled to the voltage detection module, and the voltage comparison module is configured to: compare the common voltage extreme value with a common voltage threshold range, and send, when the common voltage extreme value is out of the common voltage threshold range, a comparison result to the polarity inversion control module; and
wherein the polarity inversion control module is coupled to the voltage comparison module, and the polarity inversion control module controls the display module to display in a pre-stored polarity inversion manner in response to the comparison result, wherein the pre-stored polarity inversion manner is different from the current polarity inversion manner,
wherein the common voltage extreme value comprises a common voltage maximum value and a common voltage minimum value, and wherein it is determined that the common voltage extreme value is out of the common voltage threshold range when the common voltage maximum value is greater than a maximum value of a common voltage threshold range or when the common voltage minimum value is smaller than a minimum value of the common voltage threshold range,
wherein the polarity inversion control module controlling the display module to display in the pre-stored polarity inversion manner comprises:
when displaying a p-th pixel row in the display module, |n₁−m₁|<Δp, where n₁ denotes a number of data lines on each of which a data voltage jumps from a lower level to a higher level when displaying in the pre-stored polarity inversion manner, m₁ denotes a number of data lines on each of which a data voltage jumps from a higher level to a lower level when displaying in the pre-stored polarity inversion manner, and n₁, m₁ and p are positive integers, Δp=|n₀−m₀|, n₀ denotes a number of data lines on each of which a data voltage jumps from a lower level to a higher level when the p-th pixel row is displayed in the current polarity inversion manner, and m₀ denotes a number of data lines on each of which a data voltage jumps from a higher level to a lower level when the p-th pixel row is displayed in the current polarity inversion manner.

19. The display module according to claim 18, further comprising a timing controller coupled to the polarity inversion control module;
wherein the polarity inversion control module controlling the display module to display in a pre-stored polarity inversion manner in response to the comparison result comprises: the polarity inversion control module generating a trigger signal in response to the comparison result, and sending the trigger signal to the timing controller;
wherein the timing controller changes at least one polarity inversion signal in response to the trigger signal, so as to control the display module to display in the pre-stored polarity inversion manner.

20. A display device, comprising a display module, wherein the display module comprises a voltage detection module, a voltage comparison module and a polarity inversion control module;
wherein the voltage detection module is coupled to a common electrode in the display module, and the voltage detection module is configured to detect a common voltage extreme value from a common voltage waveform when the display module displays in a current polarity inversion manner;
wherein the voltage comparison module is coupled to the voltage detection module, and the voltage comparison module is configured to: compare the common voltage extreme value with a common voltage threshold range, and send, when the common voltage extreme value is out of the common voltage threshold range, a comparison result to the polarity inversion control module; and
wherein the polarity inversion control module is coupled to the voltage comparison module, and the polarity inversion control module controls the display module to display in a pre-stored polarity inversion manner in response to the comparison result, wherein the pre-stored polarity inversion manner is different from the current polarity inversion manner,
wherein the common voltage extreme value comprises a common voltage maximum value and a common voltage minimum value, and wherein it is determined that the common voltage extreme value is out of the common voltage threshold range when the common voltage maximum value is greater than a maximum value of a common voltage threshold range or when the common voltage minimum value is smaller than a minimum value of the common voltage threshold range,
wherein the polarity inversion control module controlling the display module to display in the pre-stored polarity inversion manner comprises:
when displaying a p-th pixel row in the display module, |n₁−m₁|<Δp, where n₁ denotes a number of data lines on each of which a data voltage jumps from a lower level to a higher level when displaying in the pre-stored polarity inversion manner, m₁ denotes a number of data lines on each of which a data voltage jumps from a higher level to a lower level when displaying in the pre-stored polarity inversion manner, and n₁, m₁ and p are positive integers, Δp=|n₀−m₀|, no denotes a number of data lines on each of which a data voltage jumps from a lower level to a higher level when the p-th pixel row is displayed in the current polarity inversion manner, and m₀ denotes a number of data lines on each of which a data voltage jumps from a higher level to a lower level when the p-th pixel row is displayed in the current polarity inversion manner.
